(19) United States
(12) Patent Application Publication
(10) Pub. No.: US 2007/0050808 A1
(43) Pub. Date: Mar. 1, 2007

(54) Program content reproduciton apparatus capable of appropriately notifying viewer of presence of sub content

(75) Inventors: Tetsuya Matsuyama, Ichikawa-Shi (JP); Toru Ueda, Kyoto (JP); Toshihide Hagawa, Chiba-Shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-Shi (JP)

(21) Appl. No.: 11/228,357

(22) Filed: Sep. 19, 2005

Related U.S. Application Data
(60) Provisional application No. 60/712,145, filed on Aug. 30, 2005.

(30) Foreign Application Priority Data
Aug. 26, 2005 (JP) 2005-245786

(51) Int. Cl. H04N 7/167; H04N 7/16

(52) U.S. Cl. 725/31; 725/25

(57) ABSTRACT

A program content reproduction apparatus obtains a program content and authentication information transmitted from a broadcast station at a broadcast reception unit, and obtains sub content data transmitted from a server at a communication unit. The program content is reproduced and displayed by a program content reproduction unit. The sub content data is stored in a sub content data storage unit and authenticated by a sub content data authentication unit based on the authentication information. If the sub content data is approved, presence of the sub content data is presented on the reproduced program content by a sub content data presence display unit.

### FIELD OF THE INVENTION

The present invention relates to a program content reproduction apparatus, and more particularly to a program content reproduction apparatus capable of indicating to a viewer presence of a sub content related to a program during broadcast of the program.

### DESCRIPTION OF THE BACKGROUND ART

At present, in terrestrial digital broadcasting, satellite digital broadcasting or the like, latest news and weather forecast, information on a program that is being broadcast (program-related information) or the like is provided by utilizing data broadcasting. In data broadcast technology, characters, images and layout of the program-related information displayed on a screen are defined by a language called BML (Broadcast Markup Language). By utilizing the data broadcast technology, a viewer can not only view a program but also make transmission to the program that is being broadcast or to a broadcast station. Namely, the viewer can join a quiz show or purchase merchandise presented in a shopping program. Such program-related information is provided also by EPG (Electronic Program Guide), so that the viewer can obtain information such as performers and story of a program by designating the program on the displayed EPG.

Such program-related information is not only contained in the data broadcast but also provided on the Internet through communication lines. Japanese Patent Laying-Open No. 2005-026867 (hereinafter referred to as Patent Document 1) proposes a reception terminal aiming to integrate broadcast and communication so that a user can enjoy various services. The reception terminal receives information on a link such as URL (Uniform Resource Locator) on the Internet as the program-related information contained in the data broadcast, and displays a special symbol such as an icon indicating presence at the link of the program-related information in a display field of a corresponding program on the EPG. The user selects this icon, so that the program-related information present on the Internet can be obtained.

Here, as a result of following a hyperlink described in the program-related information, the user may unconsciously be connected to a server providing information that is not the program-related information, and may view that information, believing that the program-related information is provided.

As a method to solve this problem, Japanese Patent Laying-Open No. 2003-209542 (hereinafter referred to as Patent Document 2) proposes a broadcast receiver that transmits to a terminal a list of addresses of servers utilized for program-related services for each time zone and indicates to the user whether the service he/she uses is related to the program or not. In addition, Japanese Patent Laying-Open No. 2002-344407 (hereinafter referred to as Patent Document 3) proposes, as a method of authenticating a server by using airwave, a broadcast reception system in which a public key for authenticating a certificate of a WEB server is transmitted through airwave, thereby eliminating the need to operate an authentication station and reducing management cost.

Japanese Patent Laying-Open No. 2004-343683 (hereinafter referred to as Patent Document 4) proposes a multimedia data processing apparatus such as a portable phone or a portable terminal, capable of readily creating a multimedia content by utilizing a template as well as various functions such as a camera, a microphone and an address book contained specifically to the terminal. In such a multimedia data processing apparatus, various functions are called sequentially in a time-series manner according to a script described in the template. Therefore, the user should only perform an operation adapted to a user interface at prescribed timing for creating the multimedia content.

With widespread use of a tuner-containing portable phone on which a TV program can be viewed, it will be more common for the user to view various types of digital broadcasting on a portable phone. Accordingly, with regard to the services provided through data broadcasting, it is necessary to take into consideration viewing not only on a home television but also on a portable phone. For example, the template described above is provided through data broadcasting instead of program-related information defined by BML, so that the user can easily obtain data necessary for using the service by utilizing the functions specific to the portable phone such as a camera, a microphone and an address book.

If the template described above is obtained through other communication means represented by the Internet instead of data broadcasting, however, it is not clear which template provides which program-related service, that is, association therebetween is not clear.

The broadcast receiver according to Patent Document 2 determines such association not based on the content of the template itself but based on the address of the server. Therefore, if this method is applied to the multimedia data processing apparatus according to Patent Document 4 as it is, relation with a program cannot be determined until connection with the server is established by the multimedia data processing apparatus that interprets the template.

In addition, if the broadcast reception system according to Patent Document 3 is applied to the multimedia data processing apparatus according to Patent Document 4, association with a program cannot be determined either, although it is ensured that the server has been approved by the authentication station.

### SUMMARY OF THE INVENTION

The present invention was made in view of the above-described problems. An object of the present invention is to provide a program content reproduction apparatus capable of determining association between a program and a sub content such as a template stored in a terminal, and appropriately notifying a viewer of presence of the sub content.

In order to achieve the object described above, according to one aspect of the present invention, a program content reproduction apparatus includes a broadcast reception unit for obtaining a program content and authentication information; a program content reproduction unit for reproducing the program content; a sub content data storage unit for storing sub content data; a sub content data authentication unit for authenticating the sub content data stored in the sub content data storage unit based on the authentication information; and a sub content data presence presenting unit for presenting presence of the sub content data during reproduction of the program content by the program content reproduction unit based on a result of authentication by the sub content data authentication unit.

Preferably, the sub content data presence presenting unit presents solely presence of the sub content data approved by the sub content data authentication unit.

Preferably, the sub content data presence presenting unit presents, in a different manner, the sub content data approved by the sub content data authentication unit and the sub content data not approved by the same.

Preferably, the authentication information is a public key, the sub content data is additionally provided with electronic signature by means of a secret key paired with the public key, and the sub content data authentication unit authenticates the sub content data by verifying authenticity of the electronic signature with the public key.

Preferably, the program content reproduction apparatus further includes a sub content data selection unit for selecting the sub content data of which presence has been presented by the sub content data presence presenting unit, and a sub content data reproduction unit for reproducing the sub content data selected by the sub content data selection unit.

Preferably, the program content reproduction apparatus further includes a message creation unit for creating a fixed-format message based on information contained in the sub content data and input by a user, and a message transmission unit for transmitting the message created by the message creation unit.

Preferably, the program content reproduction apparatus further includes an obtaining unit for obtaining the sub content data from other apparatus, and communication means different from the broadcast reception unit and the obtaining unit is employed.

According to another aspect of the present invention, a program content reproduction apparatus includes: a broadcast reception unit for obtaining a program content and authentication information; a program content reproduction unit for reproducing the program content; a sub content data storage unit for storing sub content data; a sub content data authentication unit for authenticating the sub content data stored in the sub content data storage unit based on the authentication information; and a sub content data reproduction unit for reproducing the sub content data approved by the sub content data authentication unit.

Preferably, the sub content data has priority, and the sub content data reproduction unit reproduces the sub content data having highest priority if there are a plurality of pieces of sub content data approved by the sub content data authentication unit.

The program content reproduction apparatus configured as above according to one aspect of the present invention authenticates the sub content data such as a template stored in the terminal based on the authentication information contained in the airwave, and determines solely the approved sub content as the information related to the program being broadcast.

Therefore, presence of the sub content data related to the program among the sub content data obtained through communication means other than broadcasting can be indicated to the viewer during broadcast of the program.

In addition, the program content reproduction apparatus according to one aspect of the present invention can display, during broadcast of the program, a list containing solely the sub content data related to the program among the sub contents obtained through communication means other than broadcasting.

Moreover, the program content reproduction apparatus according to one aspect of the present invention displays, in a different manner, the list of the sub content related to the program and the sub content data not related thereto among the sub content data obtained through communication means other than broadcasting, during broadcast of the program.

Furthermore, the program content reproduction apparatus according to one aspect of the present invention can reproduce the sub content data selected by the user based on the displayed list.

The program content reproduction apparatus according to one aspect of the present invention can reproduce the sub content related to the program among the sub content data obtained through communication means other than broadcasting at the time intended by a broadcast station.

The program content reproduction apparatus according to one aspect of the present invention can create and transmit a message based on the information contained in the sub content data and input by a user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a specific example of a functional configuration of a program content reproduction apparatus 113 according to a first embodiment.

FIG. 2 is a flowchart showing a specific example of processing in program content reproduction apparatus 113 according to the first embodiment.

FIG. 3 is a diagram showing a specific example of sub content data according to the first embodiment.

FIG. 4 is a diagram showing a specific example of a program content reproduced at step S202.

FIG. 5 is a diagram showing a first specific example of a method of presenting presence of sub content data at step S206.

FIG. 6 is a diagram showing a second specific example of the method of presenting presence of sub content data at step S206.

FIG. 7 is a diagram showing a specific example of a method of selecting sub content data at step S207.

FIGS. 8A to 8D are diagrams showing specific examples of display on a screen when sub content data is reproduced by a sub content data reproduction unit 108 at step S208.

FIG. 9 is a diagram showing a specific example of transmission data transmitted from the program content reproduction apparatus to a server.

FIG. 10 is a diagram illustrating an outline of an authentication method utilizing electronic signature in public key cryptography as an authentication method at step S205.

FIG. 11 is a block diagram showing a specific example of a functional configuration of program content reproduction apparatus 113 according to a second embodiment.

FIG. 12 is a flowchart showing a specific example of processing in program content reproduction apparatus 113 according to the second embodiment.

FIG. 13 is a diagram showing a specific example of sub content data according to the second embodiment.

FIG. 14 is a diagram showing a specific example of relation between broadcast duration of a program content and a period during which a public key is valid.

FIG. 15 is a diagram showing a specific example of a hardware configuration of program content reproduction apparatus 113 according to the present embodiment.

### DESCRIPTION OF THE PREFERRED EMBODIMENTS

An embodiment of the present invention will be described hereinafter with reference to the drawings. The same elements and components have the same reference characters allotted. Their label and function are also identical.

In the present embodiment, it is assumed that the program content reproduction apparatus according to the present invention is suitably implemented by a portable phone attaining a TV broadcast reception function and an Internet communication function.

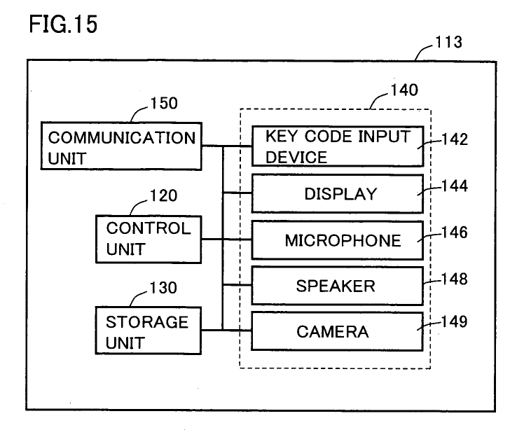

FIG. 15 shows a specific example of a hardware configuration of program content reproduction apparatus 113 according to the present embodiment, implemented herein by a portable phone.

Referring to FIG. 15, program content reproduction apparatus 113 according to the present embodiment implemented herein by a portable phone is constituted of an input/output portion 140 serving as an interface with a user, a control unit 120 constituted of a CPU (Central Processing Unit) and the like and controlling program content reproduction apparatus 113 as a whole, a communication unit 150 for establishing communication with other apparatus, and a storage unit 130 constituted of an ROM (Read Only Memory), an RAM (Random Access Memory) and the like and storing a program to be executed in control unit 120, intermediate data of the program, data received from other computer, and the like.

Input/output portion 140 includes a key code input device 142 including a numeric keypad such as “1”, “2” and the like and a direction key such as “R”, “L” and the like, a display 144 such as an LCD (Liquid Crystal Display) for displaying information to a user, a microphone 146 for input of voice and sound, a speaker 148 for output of voice and sound, and a camera 149 for image pick-up and input.

Control unit 120 contains a timer.

Processing in program content reproduction apparatus 113 is performed by hardware of program content reproduction apparatus 113 and software stored in storage unit 130 and executed by control unit 120. An operation as a portable phone of program content reproduction apparatus 113 shown in FIG. 15 is well known.

Program content reproduction apparatus 113 according to the present embodiment receives a program content from a broadcast station 111 through airwave, and is able to communicate with a server 112 through a network such as the Internet.

Server 112 provides, for example, a “blog” viewing service for viewing a “blog” (Weblog; a generic name of a web page serving like a personal journal updated daily), a “blog ” posting service for posting a “blog”, a book information providing service for providing book information such as an author, a publisher, a price and the like of a book, a price comparing service for comparing prices of merchandise, a merchandise purchasing service for purchasing merchandise (such as a book, a DVD (Digital Video Disk), a CD (Compact Disk) and the like)), an on-line storage service accumulating image data or photo data transmitted from the program content reproduction apparatus, a polling service for answering a questionnaire (polling) or the like from a terminal for using the service, and the like. It is noted that these services are merely examples of those provided by server 112, and there are other various services available.

In addition, there may be one server or a plurality of servers capable of establishing communication with program content reproduction apparatus 113, and one server may provide one service or a plurality of services.

(First Embodiment)

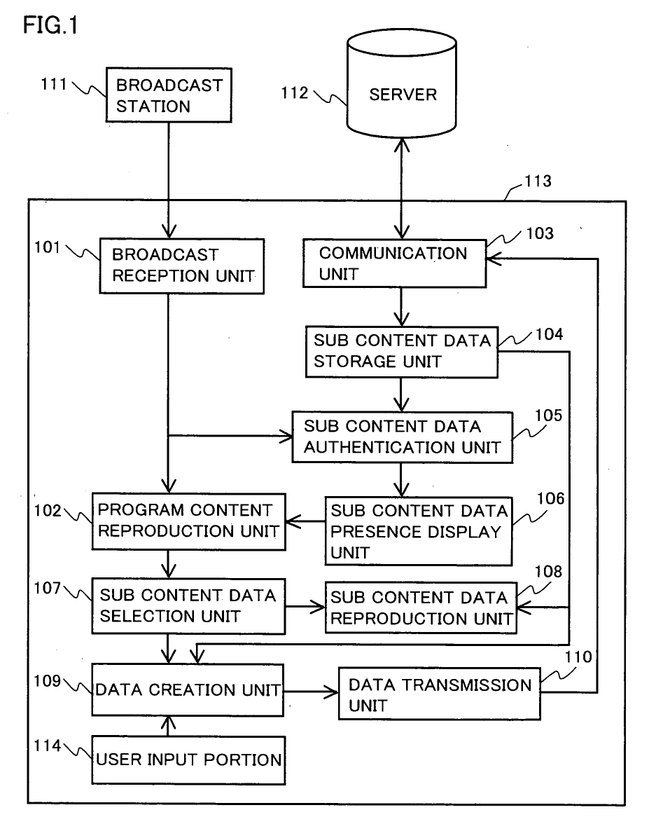

FIG. 1 is a block diagram showing a specific example of a functional configuration of program content reproduction apparatus 1 13 according to the first embodiment. Control unit 120 reads and executes the program stored in storage unit 130 and controls each unit shown in FIG. 15, so that each function shown in FIG. 1 is attained in program content reproduction apparatus 113.

Referring to FIG. 1, program content reproduction apparatus 113 according to the first embodiment is constituted of: a broadcast reception unit 101, a communication unit 103 and a data transmission unit 110 implemented by communication unit 150 and the like; a sub content data storage unit 104 occupying a prescribed area of storage unit 130; a sub content data selection unit 107 and a user input portion 114 implemented by input/output portion 140 and the like; and a program content reproduction unit 102, a sub content data authentication unit 105, a sub content data presence display unit 106, a sub content data reproduction unit 108, and a data creation unit 109 each representing a function formed in control unit 120 as a result of execution of a program in control unit 120.

Broadcast reception unit 101 receives airwave transmitted from the broadcast station and containing a program content and authentication information related to the program content, and inputs the program content and the authentication information to program content reproduction unit 102 and to sub content data authentication unit 105, respectively. The authentication information is transmitted, for example, as data broadcasting in digital broadcasting. The authentication information is suitably a public key, which will be described in detail later.

Communication unit 103 establishes communication or radio communication with server 112 through the Internet or a leased circuit, and receives data containing sub content data from server 112. The sub content data is suitably a template, and the sub content data will be described in detail later. The sub content data received by communication unit 103 is stored in sub content data storage unit 104.

Sub content data authentication unit 105 reads the sub content data from sub content data storage unit 104, and authenticates the sub content data based on the authentication information input from broadcast reception unit 101. The result of authentication is input to sub content presence display unit 106.

Sub content presence display unit 106 generates display data for displaying a list of sub content data indicating presence of the sub content based on the authentication result input from sub content authentication unit 105, and inputs the generated display data to program content reproduction unit 102. Program content reproduction unit 102 reproduces the program content input from broadcast reception unit 101, and displays the list of the sub content data on the program content based on the display data input from sub content presence display unit 106.

Sub content data selection unit 107 is implemented specifically by combination of an up key, a down key and a numeric keypad with an enter key. The viewer changes a candidate for desired sub content data in the list of the sub content data displayed on the program content by using the up key, the down key or the numeric keypad, and performs an operation to instruct with the enter key that the currently selected candidate is his/her final selection. Sub content data selection unit 107 accepts an instruction operation from the viewer, and inputs the result of selection to sub content data reproduction unit 108 and data creation unit 109.

Sub content data reproduction unit 108 obtains necessary content data from sub content data storage unit 104 based on the selection result input from sub content data selection unit 107, and reproduces the data. User input portion 114 accepts an input from the user involved with reproduction of the sub content data, and passes an input signal to data creation unit 109.

Data creation unit 109 creates transmission data, which is a fixed-format message, based on the selection result input from sub content data selection unit 107 and the user operation input through user input portion 114, and inputs the transmission data to data transmission unit 110. Data transmission unit 110 transmits the transmission data to server 112 through communication unit 103.

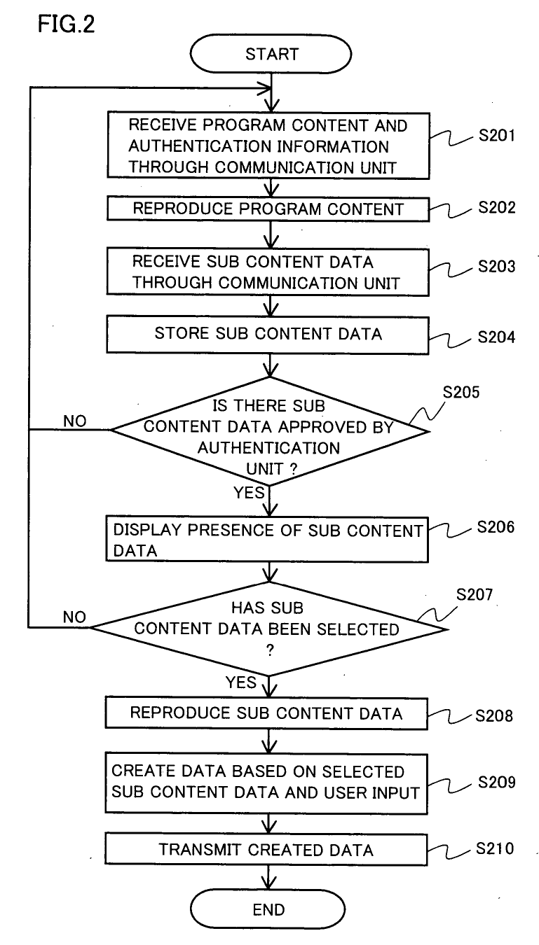

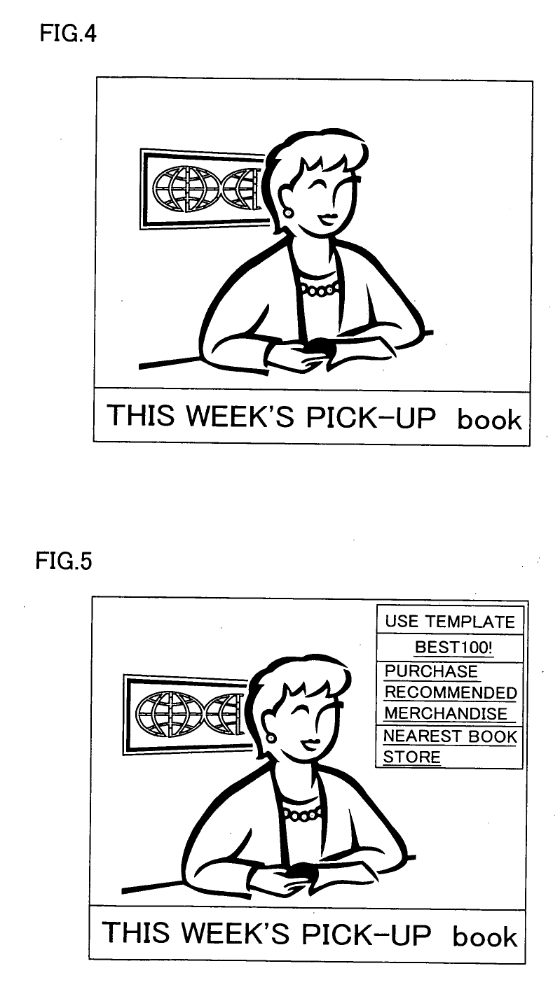

FIG. 2 is a flowchart showing a specific example of processing in program content reproduction apparatus 113 according to the first embodiment. Control unit 120 reads and executes the program stored in storage unit 130 so as to attain each function shown in FIG. 1, whereby the processing shown in the flowchart in FIG. 2 is performed. FIGS. 4 to 7 illustrate specific examples of display on the screen when the program content is reproduced in program content reproduction apparatus 113.

Referring to FIG. 2, initially, the program content from broadcast station 111 is received at broadcast reception unit 101, and the authentication information from server 112 is received at communication unit 103 (step S201). Then, the program content is reproduced by program content reproduction unit 102 (step S202).

FIG. 4 is a diagram showing a specific example of the program content reproduced at step S202. Specifically, it is assumed here that a program providing information on a book popular in recent days is reproduced.

The sub content data transmitted from server 112 is received at communication unit 103 (step S203), and stored in sub content data storage unit 104 (step S204). Reception of the sub content data at step S203 may be performed at other timing, instead of the timing after reception at step S201 and reproduction at step S202.

Then, sub content data stored in sub content data storage unit 104 is authenticated in sub content data authentication unit 105 based on the authentication information related to the program content received at step S201 and reproduced at step S202 (step S205). Authentication processing at step S205 will be described later.

If there is no approved sub content data in sub content data storage unit 104 as a result of the processing at step S205 (NO at step S205), the process returns to step S201.

Meanwhile, if there is approved sub content data in sub content data storage unit 104 as a result of the processing at step S205 (YES at step S205), presence of the sub content data approved at step S205 is presented on the program content reproduced by program content reproduction unit 102 (step S206).

FIG. 5 is a diagram showing a first specific example of a method of presenting presence of the sub content data at step S206.

According to the first method, sub content data presence display unit 106 generates display data for displaying a list showing solely the approved sub content data. Referring to FIG. 5, such a list is displayed in a manner superposed on the program content reproduced by program content reproduction unit 102, for presenting to the viewer the approved sub content data.

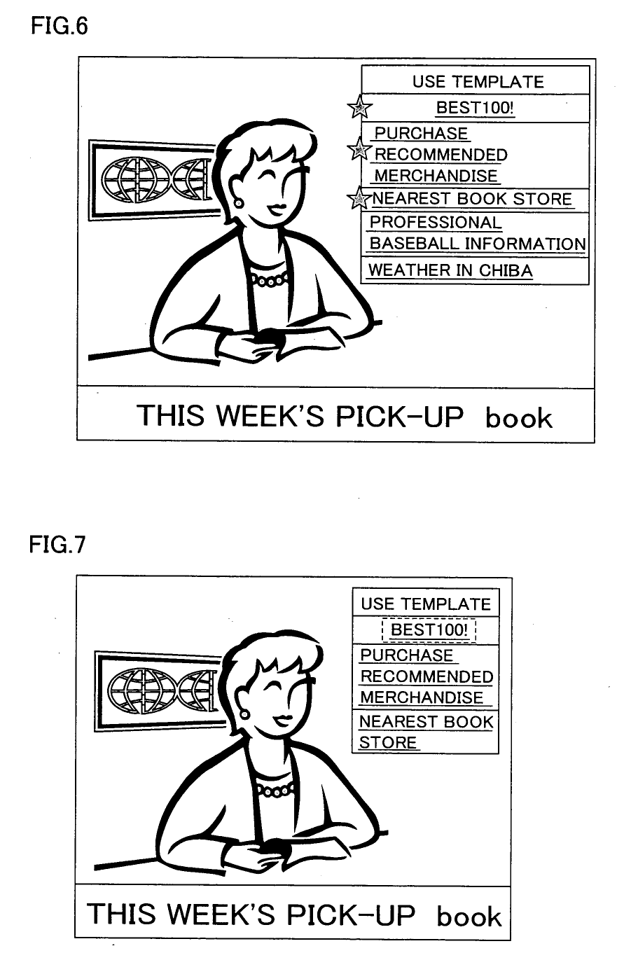

FIG. 6 is a diagram showing a second specific example of the method of presenting presence of the sub content data at step S206.

According to the second method, sub content data presence display unit 106 generates display data for displaying a list showing, in a different manner, the approved sub content data and the non-approved sub content data among all sub content data stored in sub content data storage unit 104. Referring to FIG. 6, such a list is displayed in a manner superposed on the program content reproduced by program content reproduction unit 102, for presenting to the viewer the approved sub content data. Specifically, as shown in FIG. 6, a star-shaped symbol is given solely to the approved sub content data in the vicinity of character string in the list showing the sub content data, while character string in the list showing the non-approved sub content data is displayed in a font smaller than that for the character string in the list showing the approved sub content data. The manner of display is thus made different, so that all sub content data stored in sub content data storage unit 104 are shown as a list and the viewer is easily notified of which sub content is approved by that program.

The method of presenting presence of the sub content data is not limited to the specific examples shown in FIGS. 5 and 6, and any method may be employed, provided that the viewer is notified of which sub content data has been approved or has not been approved.

The method of presenting presence of the sub content data is not limited to displaying, and the sub content data may be presented with other output method such as audio output. For example, if the output method is implemented by audio output, in order to notify the viewer of which sub content data has been approved or has not been approved, it is preferable to do so by utilizing a different output manner, for example, by outputting the approved and non-approved sub content data at a different volume level or in a different frequency range.

Then, when selection of desired sub content data is accepted from the viewer through sub content data selection unit 107 based on the display indicating presence of the sub content data presented on the program content at step S206 (YES at step S207), the sub content data selected from sub content data storage unit 104 is obtained and reproduced by sub content data reproduction unit 108 (step S208). The processing at step S208 will be described later.

FIG. 7 is a diagram showing a specific example of a method of selecting sub content data at step S207. FIG. 7 shows that the character string “BEST 100!” representing one piece of sub content data is highlighted, and therefore this sub content is a candidate. The highlight on the character string representing the sub content data can be changed by using the up key and the down key that implement sub content data selection unit 107, and as a result of pressing the enter key implementing sub content data selection unit 107 after such change in a highlighted item, finally highlighted sub content data is selected as the sub content data to be reproduced. When the enter key shown in FIG. 7 is pressed, the sub content data represented by the character string “BEST 100!” is selected as the sub content data to be reproduced.

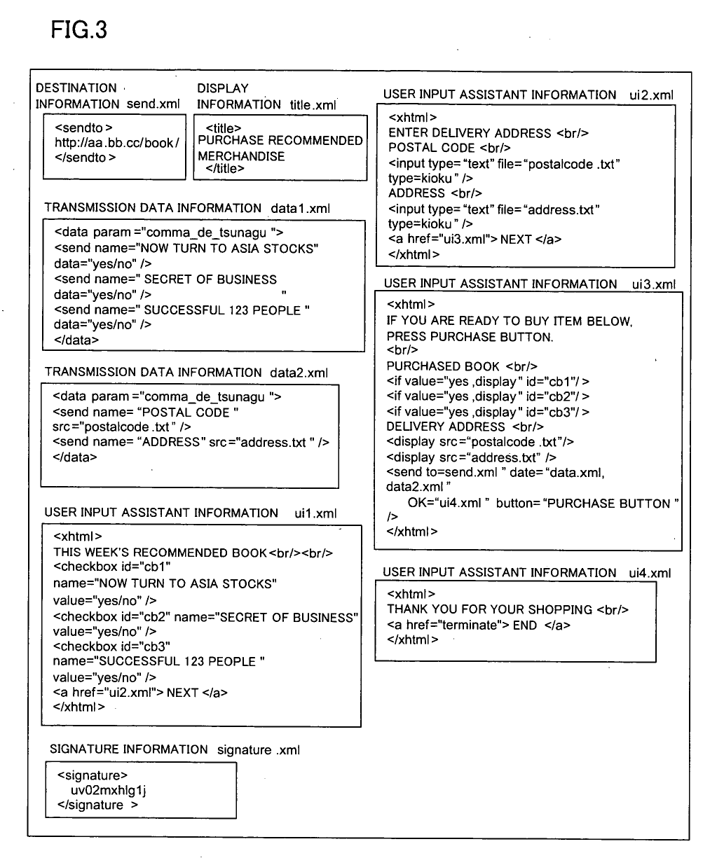

FIG. 3 shows a specific example of the sub content data according to the first embodiment, and illustrates a detailed specific example of the sub content data displayed as “purchase recommended merchandise” among displayed items indicating presence of the sub content data shown in FIGS. 5 and 6. The sub content data serves for reproduction of the sub content that the viewer utilizes when he/she purchases a book recommended in the program.

Referring to FIG. 3, the sub content data is constituted of display information “title.xml” defining character string representing the sub content data in the list of the sub content data indicating presence of the sub content data, user input assistant information “ui1.xml”, “ui2.xml”, . . . for assisting user input involved with reproduction of the sub content data, transmission data information “data1.xml”, “data2.xml”, . . . for creating transmission data, destination information “send.xml” representing information on a destination of the transmission data, and signature information “signature.xml” describing an electronic signature added to the sub content data.

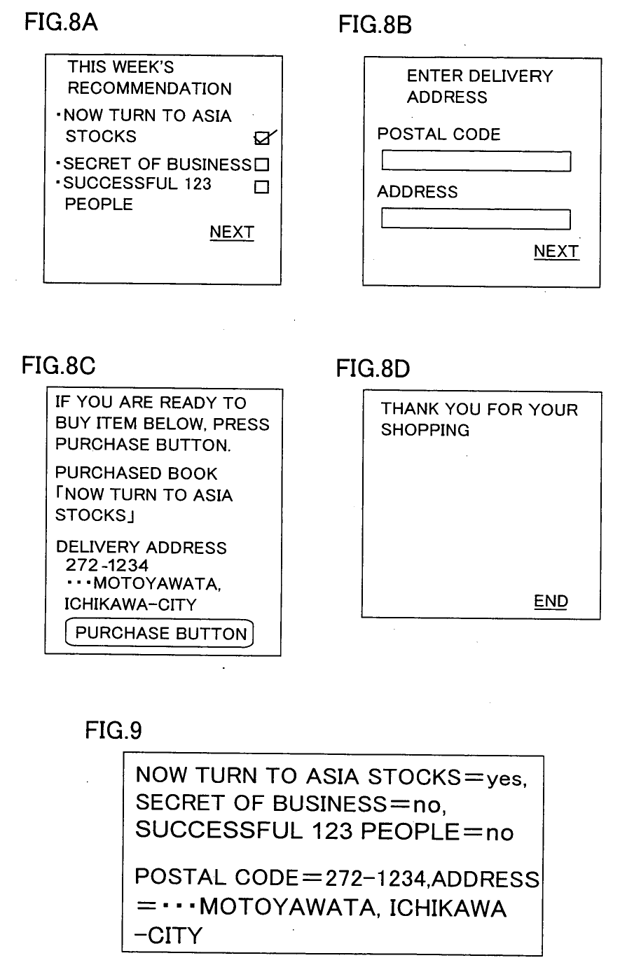

FIGS. 8A to 8D are diagrams showing specific examples of display on the screen when the sub content data is reproduced by sub content data reproduction unit 108 at step S208. FIGS. 8A to 8D show specific examples of display on the screen when the sub content data shown in FIG. 3 is reproduced.

When reproduction of the sub content data is started at step S208, initially, the content of user input assistant information “ui1.xml” is displayed as shown in FIG. 8A. Here, a title (list) of each recommended book, a check box for selecting a book to be purchased (shown next to each recommended book), and a link “next” for receiving an instruction to move to a next display screen are displayed.

When the viewer who uses the service selects a book to purchase based on the display screen in FIG. 8A (checks the check box shown next to the book that the user desires to buy) and inputs an instruction to move to the next display screen (selects “next” in a lower right portion of the display screen), the content of user input assistant information “ui2.xml” is displayed as shown in FIG. 8B.

In the screen based on user input assistant information “ui2.xml” shown in FIG. 8B, a field for input of a postal code and an address of a delivery destination of the merchandise and a link “next” for input of an instruction to move to the next display screen are displayed. As shown in FIG. 3, user input assistant information “ui2.xml” includes description for storing the input postal code and address, and if the postal code and the address have already been stored, the user input assistant information includes description for displaying that postal code and address by default (type=kioku).

When the viewer who uses the service inputs the postal code and the address of the delivery destination of the merchandise based on the display screen in FIG. 8B and inputs an instruction to move to the next display screen, the content of user input assistant information “ui3.xml” is displayed as shown in FIG. 8C.

In the screen based on user input assistant information “ui3.xml” shown in FIG. 8C, a list of purchased book, the postal code and the address of the delivery destination of the merchandise, and a purchase button are displayed.

Data creation unit 109 creates transmission data based on the selected sub content data and a user operation involved with reproduction of the sub content data and accepted through user input portion 114 (step S209).

In the specific example of the sub content data shown in FIG. 3, transmission data information “data1.xml” includes the description for including the result of selection of the book to be purchased in the transmission data which is a fixed-format message, and transmission data information “data2.xml” includes the description for including the postal code and the address of the delivery destination of the merchandise in the transmission data. Therefore, in the case of the specific example described above, at step S209, data creation unit 109 creates, based on such transmission data information, transmission data including the result of selection of the book to be purchased that is input by the viewer in the display screen in FIG. 8A, and the postal code and the address of the delivery destination of the merchandise that are input by the viewer in the display screen in FIG. 8B.

FIG. 9 is a diagram showing a specific example of the transmission data transmitted from the program content reproduction apparatus to the server. As shown in FIG. 9, the transmission data includes information input by the service user (here, information on the book to be purchased and a delivery destination of the merchandise).

The transmission data is transmitted to server 112 through communication unit 103 (step S210). That is, in the case of the specific example described above, when the viewer who uses the service selects the purchase button based on the display screen in FIG. 8C, data transmission unit 110 transmits the transmission data created based on the destination information “send.xml” at step S209 and including the book to be purchased and the postal code and the address of the delivery destination of the merchandise to the destination designated in the destination.information through communication unit 103. Server 112, i.e., the destination, may be a server different from the server that has transmitted the sub content data at step S203.

The method of obtaining the sub content data described above may be implemented by a method of obtaining the sub content data from a recording medium such as a DVD (Digital Video Disk), a CD (Compact Disk), an SD (Secure Digital) card, and the like, instead of a method of obtaining the sub content data from server 112 through communication unit 103. In such a case, program content reproduction apparatus 113 includes means for reading a recording medium instead of (or in addition to) communication unit 113, with which the sub content data is obtained from the recording medium.

Alternatively, the sub content data described above may be obtained by means of broadcast reception unit 101, as a result of transmission through the airwave.

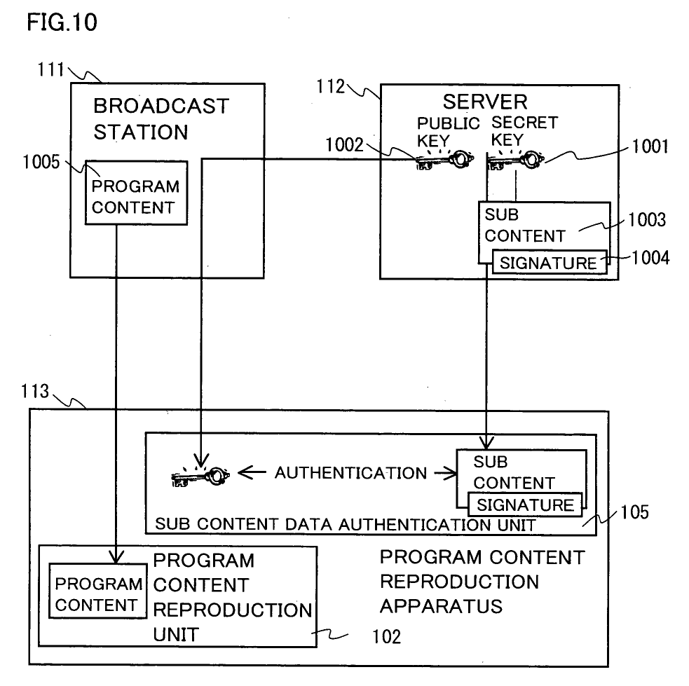

The authentication information and the authentication processing in sub content data authentication unit 105 at step S205 described above will now be described. FIG. 10 illustrates an outline of an authentication method utilizing electronic signature in public key cryptography as the authentication method at step S205.

Referring to FIG. 10, a sub content provider providing sub content data 1003 from server 112 prepares a pair of a secret key 1001 and a public key 1002. Electronic signature 1004 is added to sub content data 1003 to be provided, by using secret key 1001. Sub content data 1003 to which electronic signature 1004 has been added is output from server 112 through communication means such as the Internet, and received by communication unit 103 of program content reproduction apparatus 113.

The sub content provider requests broadcast station 111 to broadcast public key 1002 during broadcast duration of related program content 1005. Namely, public key 1002 is entrusted to broadcast station 111 from server 112.

When it is recognized that sub content data 1003 is related to program content 1005, broadcast station 111 transmits public key 1002 entrusted by the sub content provider to program content reproduction apparatus 113 through the airwave, along with program content 1005.

In program content reproduction apparatus 113, program content reproduction unit 102 reproduces program content 1005 included in the airwave received at broadcast reception unit 101. In addition, sub content data authentication unit 105 verifies authenticity of electronic signature 1004 added to sub content data 1003 by using public key 1002 paired with secret key 1001 received through the airwave, whereby sub content data 1003 is authenticated. That is, in order to associate sub content data 1003 with the program, sub content data authentication unit 105 should verify authenticity of added electronic signature 1004 for approval of sub content data 1003, and for this purpose, public key 1002 paired with secret key 1001 is required. Therefore, even if a malicious third party provides the user with sub content data created by the party himself/herself and disguised as program-related information without obtaining permission from the broadcast station, the sub content data is not approved by sub content data authentication unit 105 until secret key 1001 corresponding to public key 1002 included in the airwave received at broadcast reception unit 101 is obtained and electronic signature 1004 is added. Accordingly, in order to provide the viewer with such sub content data disguised as related to program content 1005, secret key 1001 corresponding to public key 1002 included in the airwave should be obtained, which makes it extremely difficult to provide such malicious sub content data.

Electronic signature 1004 added to sub content data 1003 and the processing for authentication in sub content data authentication unit 1005 will now be described.

The sub content data shown in FIG. 3 includes signature information “signature.xml” describing the electronic signature. The signature information is suitably obtained by encrypting, with secret key 1004, a hash value of a portion obtained by excluding the signature information from all information included in the sub content data shown in FIG. 3.

Here, at step S205, sub content data authentication unit 105 calculates a hash value of the portion obtained by excluding the signature information from all information included in the sub content data, and decrypts the signature information “signature.xml” included in the sub content data using public key 1002 included in the airwave from broadcast station 111 received at broadcast reception unit 101. If both values match, sub content data authentication unit 105 determines the sub content data as approved. Though solely the hash value has been described as the electronic signature, for example, “XML Signature”, a language for electronic signature based on XML (Extensible Markup Language) standardized by W3C (World Wide Web Consortium), may be used.

Authentication of the sub content data by sub content data authentication unit 105 may be performed by using a simplified method such as matching of IDs and character strings, instead of verifying the electronic signature included in the sub content data by using the public key included in the airwave as described previously. Namely, sub content data authentication unit 105 may authenticate the sub content data by verifying matching between an ID included in the airwave and an ID included in the sub content data.

The processing described above is performed in the program content reproduction apparatus according to the present embodiment, so that the program content reproduction apparatus can present to the viewer, during broadcast of the program, presence of the sub content data related to the program, among the sub content data such as templates obtained through communication means other than broadcasting (such as the Internet). In addition, the list containing solely the sub content data related to the program can be displayed during broadcast of the program. Alternatively, the sub content data related to the program and the sub content data not related thereto can be displayed in a different manner for displaying the list, during broadcast of the program.

Therefore, the viewer can select reproduction of desired sub content data based on the list, and the program content reproduction apparatus can reproduce the sub content data selected by the user based on the displayed list.

In addition, the program content reproduction apparatus can create the transmission data based on the information included in the sub content data and the input by the user, and can transmit the data to a prescribed destination.

(Second Embodiment)

According to the first embodiment, the approved sub content data is displayed on the program content and reproduced after selection by the user. Meanwhile, according to the second embodiment, the sub content data is automatically reproduced, without waiting for selection by the user.

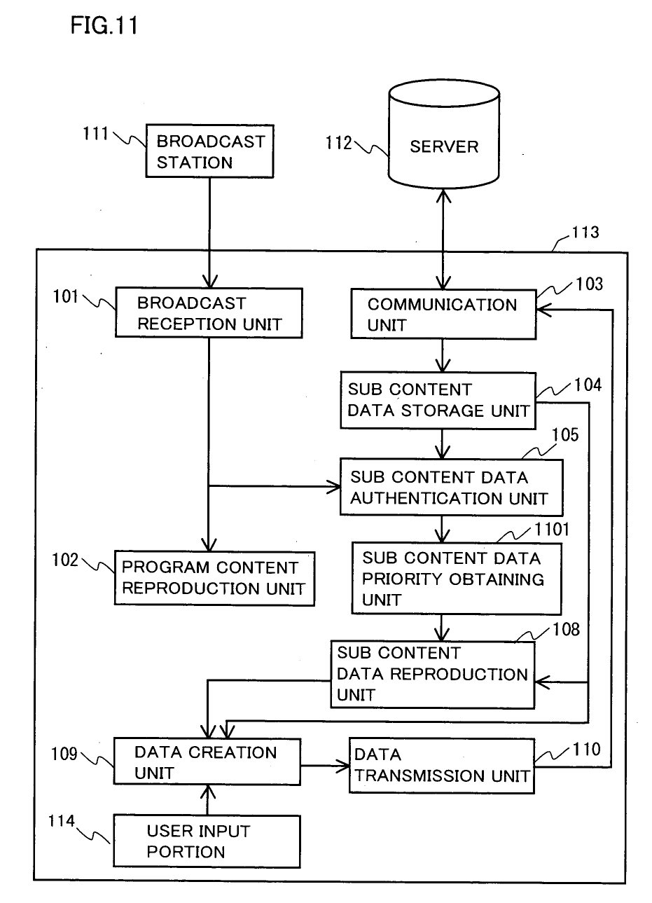

FIG. 11 is a block diagram showing a specific example of a functional configuration of program content reproduction apparatus 113 according to the second embodiment. Control unit 120 again reads and executes the program stored in storage unit 130 and controls each unit shown in FIG. 15, so that each function shown in FIG. 11 is attained in program content reproduction apparatus 113.

Referring to FIG. 11, program content reproduction apparatus 113 according to the second embodiment includes a sub content data priority obtaining unit 1101 instead of sub content data presence display unit 106 and sub content data selection unit 107, among the functions attained by program content reproduction apparatus 113 according to the first embodiment shown in the drawings.

Sub content data authentication unit 105 inputs the result of authentication to sub content data priority obtaining unit 1101. Sub content data priority obtaining unit 1101 obtains the priority of the approved sub content data based on the authentication result input from sub content authentication unit 105, and selects reproducible sub content data. Thereafter, sub content data priority obtaining unit 1101 inputs the result of selection to sub content data reproduction unit 108.

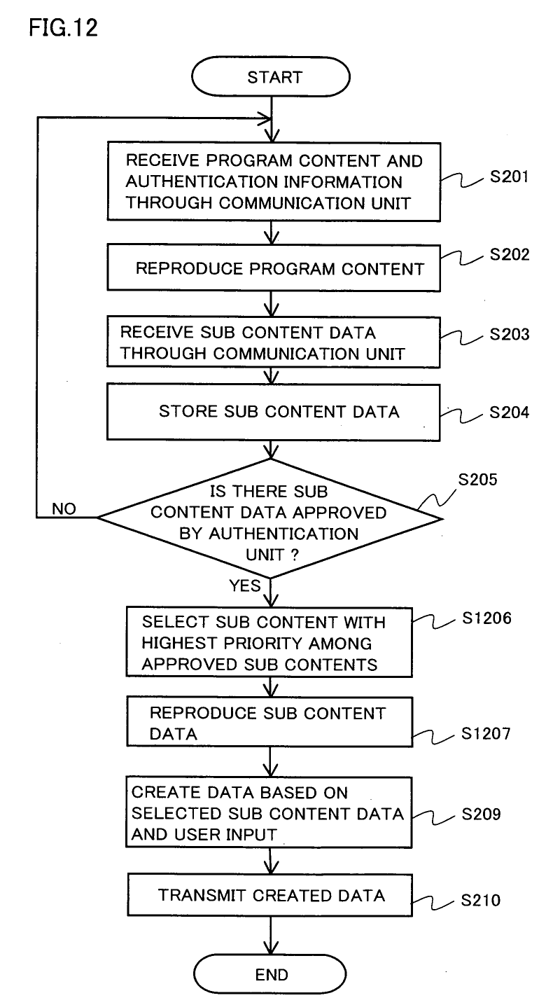

FIG. 12 is a flowchart showing a specific example of the processing in program content reproduction apparatus 113 according to the second embodiment. Control unit 120 again reads and executes the program stored in storage unit 130 so as to attain each function shown in FIG. 11, whereby the processing shown in the flowchart in FIG. 12 is performed. Among the processing shown in the flowchart in FIG. 12, the processing at steps S201 to 205, S209, and S210 is the same as that in program content reproduction apparatus 113 according to the first embodiment shown in the flowchart in FIG. 2. Therefore, description of processing different from that in program content reproduction apparatus 113 according to the first embodiment will be given.

Referring to FIG. 12, if there is approved sub content data in sub content data storage unit 104 as a result of the processing at step S205 (YES at step S205) and when there are a plurality of pieces of sub content data reproducible without waiting for selection by the user among the sub content data approved at step S205, the data having the highest priority is selected by sub content priority obtaining unit 1101 (step S1206). At step S1206, the selected sub content data is reproduced by sub content data reproduction unit 108 (step S1207).

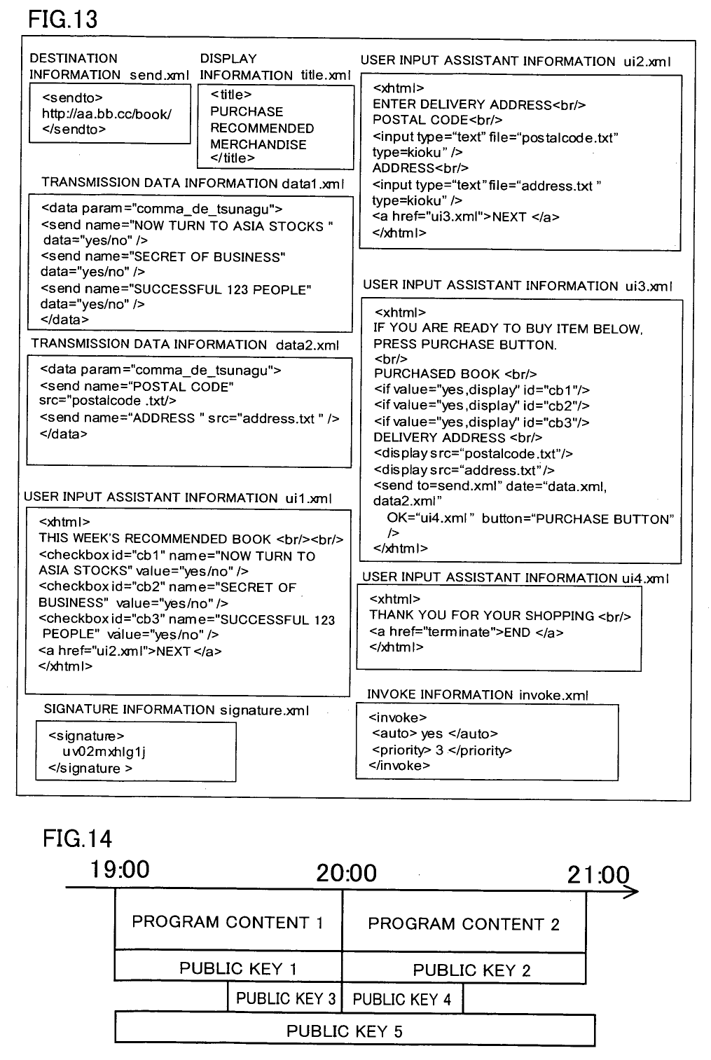

FIG. 13 is a diagram showing a specific example of the sub content data according to the second embodiment.

The sub content data according to the present embodiment further includes invoke information “invoke.xml”, in addition to each information included in the sub content data according to the first embodiment shown in FIG. 3. Invoke information “invoke.xml” describes whether the content data is reproducible without waiting for selection by the user, as well as priority.

At step S1206, sub content priority obtaining unit 1101 refers to this information, and selects the sub content data that is reproducible without waiting for selection by the user and has the highest priority.

(Third Embodiment)

In the third embodiment, a period during which the public key is valid will be described.

In program content reproduction apparatus 113 shown in the first and the second embodiments, authentication of the sub content data is carried out by a unit of program content. Therefore, for example, once the public key is transmitted to program content reproduction apparatus 113 at the start of broadcast of the program content, authentication of the sub content data can be realized during reproduction of the program content. In the third embodiment, an authentication method not by a unit of program content but by a unit of time will be described.

FIG. 14 is a diagram showing a specific example of relation between broadcast duration of a program content and a period during which the public key is valid.

Referring to FIG. 14, the period during which a public key 1 and a public key 2 are valid is as long as the broadcast duration of the corresponding program content. The public key described in the first and the second embodiments is the public key in such relation.

The period during which the public key is valid does not have to match with the broadcast duration of the corresponding program content. As shown with a public key 3 and a public key 4, the public key may be valid solely during a part of the broadcast duration of the corresponding program content. Alternatively, as shown with a public key 5, the public key may be valid for broadcast duration of a plurality of program contents.

The broadcast station provides such a public key, for example, to program content reproduction apparatus 113 according to the second embodiment, so that the broadcast station can authenticate specific sub content data in program content reproduction apparatus 113 at a desired time. That is, the specific sub content data can be reproduced in program content reproduction apparatus 113 at the time desired by the broadcast station. This can be achieved by setting a valid period in the public key.

In each embodiment above, the template has been shown as a suitable example of the sub content data, however, general AV (Audio Visual) data such as MPEG-7 (Moving Picture Experts Group) format data may be employed, provided that the data is reproducible and includes authentication information, such as electronic signature or ID, that can be authenticated by sub content data authentication unit 105. As the MPEG-7 format data can include metadata in the data, the authentication information can be described as the metadata.

In addition, in each embodiment above, the portable phone has been shown as the most suitable example of the program content reproduction apparatus according to the present invention, however, the program content reproduction apparatus according to the present invention is applicable to a television receiver, a personal computer or a PDA (Personal Digital Assistants). Such equipment may be stationary or portable.

The method of reproducing a sub content performed in the program content reproduction apparatus described above may be provided as a program. Such a program can be recorded on a computer-readable recording medium such as a flexible disk, a CD-ROM, an ROM, an RAM, and a memory card adapted to a computer, and can be provided as a program product. Alternatively, the program may be recorded and provided in a recording medium such as a hard disk contained in the computer. Further, the program may be provided by downloading through the network.

The provided program product is installed in a program storage unit such as a hard disk for execution. It is noted that the program product includes the program itself and the recording medium recording the program.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A program content reproduction apparatus, comprising:
a broadcast reception unit for obtaining a program content and authentication information;
a program content reproduction unit for reproducing said program content;
a sub content data storage unit for storing sub content data;
a sub content data authentication unit for authenticating the sub content data stored in said sub content data storage unit based on said authentication information; and
a sub content data presence presenting unit for presenting presence of said sub content data during reproduction of said program content by said program content reproduction unit based on a result of authentication by said sub content data authentication unit.

2. The program content reproduction apparatus according to claim 1, wherein
said sub content data presence presenting unit presents solely presence of the sub content data approved by said sub content data authentication unit.

3. The program content reproduction apparatus according to claim 1, wherein
said sub content data presence presenting unit presents, in a different manner, the sub content data approved by said sub content data authentication unit and the sub content data non-approved by the same.

4. The program content reproduction apparatus according to claim 1, wherein
said authentication information is a public key,
said sub content data is additionally provided with electronic signature by means of a secret key paired with said public key, and
said sub content data authentication unit authenticates said sub content data by verifying authenticity of said electronic signature with said public key.

5. The program content reproduction apparatus according to claim 1, further comprising:
a sub content data selection unit for selecting the sub content data of which presence has been presented by said sub content data presence presenting unit; and
a sub content data reproduction unit for reproducing said sub content data selected by said sub content data selection unit.

6. The program content reproduction apparatus according to claim 5, further comprising:
a message creation unit for creating a fixed-format message based on information contained in said sub content data and input by a user; and
a message transmission unit for transmitting said message created by said message creation unit.

7. The program content reproduction apparatus according to claim 1, further comprising an obtaining unit for obtaining said sub content data from other apparatus, wherein
communication means different from said broadcast reception unit and said obtaining unit is employed.

8. A program content reproduction apparatus, comprising:
a broadcast reception unit for obtaining a program content and authentication information;
a program content reproduction unit for reproducing said program content;
a sub content data storage unit for storing sub content data;
a sub content data authentication unit for authenticating the sub content data stored in said sub content data storage unit based on said authentication information; and
a sub content data reproduction unit for reproducing said sub content data approved by said sub content data authentication unit.

9. The program content reproduction apparatus according to claim 8, wherein
said sub content data has priority, and
said sub content data reproduction unit reproduces the sub content data having highest priority if there are a plurality of pieces of sub content data approved by said sub content data authentication unit.
